(19) United States
(12) Patent Application Publication
(10) Pub. No.: US 2024/0362692 A1
(43) Pub. Date: Oct. 31, 2024

(54) SYSTEMS AND METHODS FOR NEGOTIATING THE PURCHASE OF A VEHICLE USING A CHATBOT

(71) Applicant: STATE FARM MUTUAL AUTOMOBILE INSURANCE COMPANY, Bloomington, IL (US)

(72) Inventors: Aaron Williams, Congerville, IL (US); Scott T. Christensen, Salem, OR (US); Joseph P. Harr, Bloomington, IL (US); Ryan M. Gross, Normal, IL (US)

(21) Appl. No.: 18/597,514

(22) Filed: Mar. 6, 2024

Related U.S. Application Data
(60) Provisional application No. 63/624,616, filed on Jan. 24, 2024.
(60) Provisional application No. 63/528,141, filed on Jul. 21, 2023.
(60) Provisional application No. 63/462,101, filed on Apr. 26, 2023.

(51) Int. Cl. G06Q 30/0601; G06Q 30/0283

(52) U.S. Cl. CPC G06Q 30/0611; G06Q 30/0283

(57) ABSTRACT

A computer-implemented method may include, by one or more processors and/or associated transceivers: (1) detecting a signal that a buyer would like to purchase a vehicle, wherein the signal indicates a vehicle type of the vehicle; and/or (2) inputting the vehicle type into a generative artificial intelligence (AI) model. The generative AI model is trained on transactional data associated with vehicle purchases to learn a relationship between vehicle purchase terms and buyer characteristics, and is configured to: (i) identify one or more sellers of the vehicle type; (ii) establish a communication coupling with the one or more sellers of the vehicle type; (iii) automatically negotiate, with the one or more sellers, one or more terms for purchasing available vehicles of the vehicle type; and/or (iv) present the terms to the buyer to facilitate purchase of a particular vehicle of the available vehicles from a particular seller.

### CROSS-REFERENCE TO RELATED APPLICATIONS

This application claims priority to and the benefit of the filing date of (1) provisional U.S. Patent Application No. 63/462,101 entitled “GENERATION OF VEHICLE SUGGESTIONS BASED ON DRIVER DATA,” filed on Apr. 26, 2023, (2) provisional U.S. Patent Application No. 63/528,141 entitled “GENERATION OF VEHICLE SUGGESTIONS BASED UPON DRIVER DATA,” filed on Jul. 21, 2023, and (3) provisional U.S. Patent Application No. 63/624,616 entitled “SYSTEMS AND METHODS FOR NEGOTIATING THE PURCHASE OF A VEHICLE USING A CHATBOT,” filed on Jan. 24, 2024. The entire contents of each of the above-identified applications are hereby expressly incorporated herein by reference.

### FIELD OF THE INVENTION

The present disclosure generally relates to negotiating a purchase of a vehicle and more particularly, negotiating the purchase of a vehicle using a generative artificial intelligence (AI) model such as an AI or machine learning (ML) chatbot and/or voice bot.

### BACKGROUND

Negotiating with vehicle sellers can be an intimidating and difficult task. A buyer may not have enough knowledge of vehicles or enough skill at negotiating favorable terms when purchasing a vehicle. Additionally, even if sellers list prices of vehicle for sale, sellers may often be willing to negotiate down to lower prices. However, buyers may often be unable to conduct multiple negotiations in parallel to evaluate their options. Additionally, other parts of the vehicle purchase process, such as scheduling times to test drive vehicles and negotiating loan terms from one or more loan providers, may be time-consuming for a buyer. Therefore, a tool that assists users when negotiating terms for purchasing a vehicle may be useful.

The conventional techniques for negotiating for a vehicle may include additional ineffectiveness, inefficiencies, encumbrances, and/or other drawbacks, as well.

### SUMMARY

The present embodiments may relate to, inter alia, systems and methods for implementing a generative AI model (e.g., an AI or ML chatbot and/or voice bot) to negotiate for a purchase of a vehicle.

In one aspect, a computer-implemented method for implementing generative artificial intelligence to negotiate for a purchase of a vehicle may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may include (1) detecting, by one or more processors, a signal that a buyer would like to purchase a vehicle, wherein the signal indicates a vehicle type of the vehicle; (2) inputting, by the one or more processors, the vehicle type into a generative artificial intelligence (AI) model, wherein the generative AI model is trained on transactional data associated with vehicle purchases to learn a relationship between vehicle purchase terms and user characteristics, and is configured to (i) identify one or more sellers of the vehicle type, (ii) establish a communication coupling with the one or more sellers of the vehicle type, (iii) automatically negotiate, with the one or more sellers, one or more terms for purchasing available vehicles of the vehicle type; and/or (iv) present the one or more terms to the buyer to facilitate purchase of a particular vehicle of the available vehicles from a particular seller (such as displaying text, textual, visual, or graphical output and/or purchase terms on a display, screen or other medium, and/or presenting verbal or audible output and/or purchase terms via a voice bot, chatbot, or other means). The method may include additional, less, or alternate functionality or actions, including those discussed elsewhere herein.

In another aspect, a computer system for implementing generative artificial intelligence to negotiate for a purchase of a vehicle may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to: (1) detect a signal that a buyer would like to purchase a vehicle, wherein the signal indicates a vehicle type of the vehicle; (2) input the vehicle type into a generative artificial intelligence (AI) model, wherein the generative AI model is trained on transactional data associated with vehicle purchases to learn a relationship between vehicle purchase terms and user characteristics, and is configured to (i) identify one or more sellers of the vehicle type, (ii) establish a communication coupling with the one or more sellers of the vehicle type, (iii) automatically negotiate, with the one or more sellers, one or more terms for purchasing available vehicles of the vehicle type; and/or (iv) present the one or more terms to the buyer to facilitate purchase of a particular vehicle of the available vehicles from a particular seller (such as displaying text, textual, visual, or graphical output and/or purchase terms on a display, screen or other medium, and/or presenting verbal or audible output and/or purchase terms via a voice bot, chatbot, or other means). The computer system may include additional, less, or alternate functionality, including that discussed elsewhere herein.

In another aspect, a non-transitory computer-readable medium storing processor-executable instructions for implementing generative artificial intelligence to negotiate for a purchase of a vehicle that, when executed by one or more processors, cause the one or more processors to: (1) detect a signal that a buyer would like to purchase a vehicle, wherein the signal indicates a vehicle type of the vehicle; (2) input the vehicle type into a generative artificial intelligence (AI) model, wherein the generative AI model is trained on transactional data associated with vehicle purchases to learn a relationship between vehicle purchase terms and user characteristics, and is configured to (i) identify one or more sellers of the vehicle type, (ii) establish a communication coupling with the one or more sellers of the vehicle type, (iii) automatically negotiate, with the one or more sellers, one or more terms for purchasing available vehicles of the vehicle type; and/or (iv) present the one or more terms to the buyer to facilitate purchase of a particular vehicle of the available vehicles from a particular seller (such as displaying text, textual, visual, or graphical output and/or purchase terms on a display, screen or other medium, and/or presenting verbal or audible output and/or purchase terms via a voice bot, chatbot, or other means). The instructions may direct additional, less, or alternate functionality, including that discussed elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computing environment in which methods and systems for negotiating for a vehicle are implemented, according to one embodiment.

FIG. 2 depicts a combined block and logic diagram in which exemplary computer-implemented methods and systems for training an ML chatbot are implemented, according to one embodiment.

FIG. 3 depicts a combined block and logic diagram in which exemplary computer-implemented methods and systems for using ML to negotiate for the purchase of a vehicle are implemented, according to one embodiment.

FIG. 4 depicts an exemplary display of an application employing a chatbot, according to one embodiment.

FIGS. 5A-5C depict a diagram of negotiation for the purchase of a vehicle using exemplary computer-implemented methods and systems, according to one embodiment.

FIG. 6 depicts a flow diagram of an exemplary computer-implemented method for negotiating for vehicle, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for negotiating for a vehicle using generative AI including AI or ML chatbots and/or voice bots.

In some embodiments, one or more processors may detect a signal that a buyer is interested in purchasing a vehicle, wherein the signal indicates the vehicle type. The one or more processors may input the vehicle type into a generative AI model. The AI model may identify sellers selling the vehicle type, contact the sellers, and negotiate for the vehicle. In some embodiments, generative AI models (also referred to as generative ML models) including voice bots and/or chatbots may be configured to utilize artificial intelligence and/or ML techniques. In certain embodiments, a voice or chatbot may be a ChatGPT chatbot. The voice or chatbot may employ supervised or unsupervised ML techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, augmented reality (AR) or virtual reality (VR) output, and/or other types of output for user and/or other computer or bot consumption.

### Exemplary Computing Environment

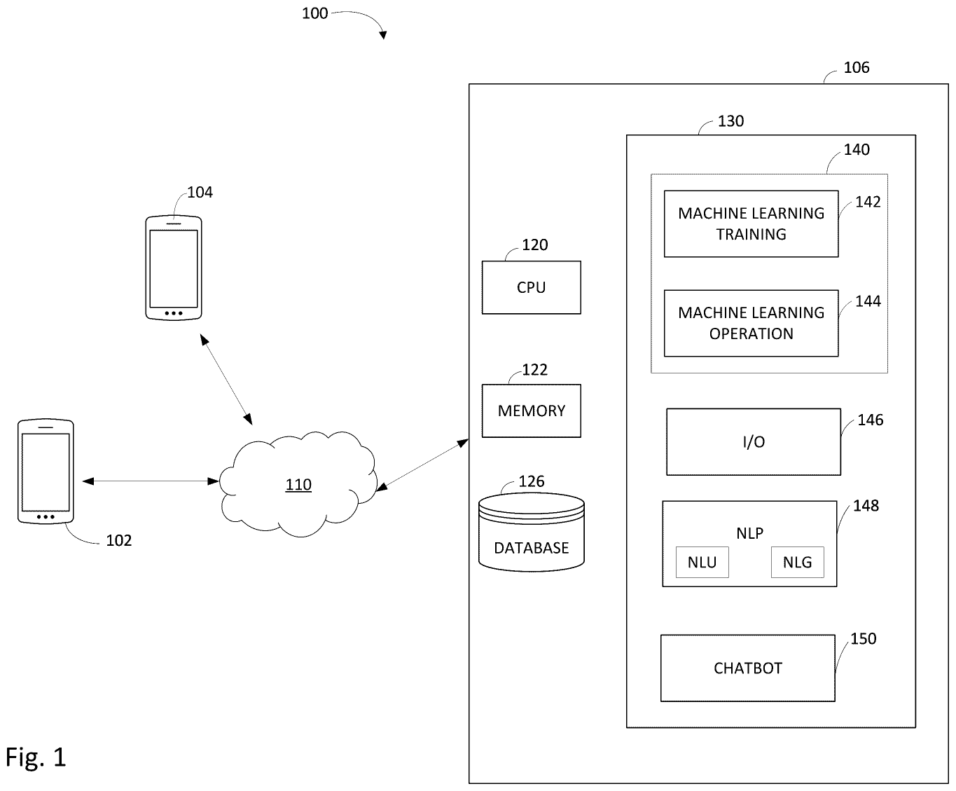

FIG. 1 depicts an exemplary computing environment 100 associated with negotiating for a vehicle. Although FIG. 1 depicts certain entities, components, equipment, and devices, it should be appreciated that additional or alternate entities, components, equipment, and devices are envisioned.

The computing environment 100 may include a user device 102, a seller communication device 104, and one or more servers 106. The user device 102, seller device 104, and servers 106 may be communicatively coupled via an electronic network 110.

As illustrated in FIG. 1, the environment 100 may include a user device 102 associated with a buyer of a vehicle. The buyer may be a driver of the vehicle, or someone purchasing a vehicle on behalf of the driver. The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

The environment 100 may also include a seller device 104. The seller device 104 may be any suitable device for communication, including one or more computers, mobile devices, wearables, smart watches, smart contact lenses, smart glasses, augmented reality glasses, virtual reality headsets, mixed or extended reality glasses or headsets, telephone, and/or other electronic or electrical component. The seller device 104 may communicate with other components of the computing environment 100 via the network 110.

In one aspect, one or more servers 106 may perform the functionalities as part of a cloud network or may otherwise communicate with other hardware or software components within one or more cloud computing environments to send, retrieve, or otherwise analyze data or information described herein. For instance, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a business) providing a chatbot to generate customized code may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by an enterprise generating the customized code. The public cloud may be partitioned using visualization and multi-tenancy techniques and may include one or more infrastructure-as-a-service (IaaS) and/or platform-as-a-service (PaaS) services.

A network 110 may comprise any suitable network or networks, including a local area network (LAN), wide area network (WAN), Internet, or combination thereof. For example, the network 110 may include a wireless cellular service (e.g., 4G, 5G, 6G, etc.). Generally, the network 110 enables bidirectional communication between the servers 106, the user device 102 and the seller device 104. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like.

The one or more servers 106 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. For example, the processors 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data that is used to train and/or operate one or more ML models, store user profile data (such as user scheduling data and/or user preferences associated with vehicles, loan terms, pricing, etc.), among other things.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 106. For example, libraries may include the TensorFlow based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the network 110. In one aspect, the servers 106 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 106 or may be indirectly accessible via or attached to an operator device. According to one aspect, an administrator or operator may access the servers 106 via an operator device to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT chatbot, an InstructGPT bot, a Codex bot, or a Google Bard bot. The voice bot or chatbot 150 may employ supervised or unsupervised ML techniques, which may be followed by, and/or used in conjunction with, reinforced or reinforcement learning techniques. The voice bot or chatbot 150 may employ the techniques utilized for ChatGPT, InstructGPT bot, Codex bot, or Google Bard bot.

Noted above, in some embodiments, a chatbot 150 or other computing device may be configured to implement ML, such that server 106 “learns” to analyze, organize, and/or process data without being explicitly programmed. In one exemplary embodiment, the ML module 140 may be configured to implement ML methods and/or algorithms.

In one embodiment, the computing environment 100 may facilitate a negotiation for the purchase of a vehicle. In one aspect, the user device 102 may transmit a signal indicating the user wishes to purchase a vehicle to the server 106. The server 106 may input data from the signal into a chatbot 150 to cause the chatbot 150 to identify one or more sellers selling the type of vehicle the buyer wants, contact the one or more sellers (e.g., via the seller device 104), and/or negotiate for purchase of the vehicle. The server 106 may provide the negotiated terms associated with a vehicle offered by the one or more sellers to the user device 102 via the network 110.

Although the computing environment 100 is shown to include one user device 102, one seller device 104, one server 106, and one network 110, it should be understood that different numbers of user devices 102, seller devices 104, servers 106, and/or networks 110 may be utilized.

The computing environment 100 may include additional, fewer, and/or alternate components, and/or may be configured to perform additional, fewer, or alternate actions, including components/actions described herein. Although the computing environment 100 is shown in FIG. 1 as including one instance of various components such as user device 102, seller device 104, server 106, network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, the user device 102 and/or the seller device 104 may be connected via a direct communication link (not shown in FIG. 1) instead of, or in addition to, via network 110.

### Exemplary Training of the ML Chatbot Model

An enterprise may be able to use programmable chatbots, such the chatbot 150 (e.g., ChatGPT), to provide tailored, conversational-like customer service relevant to a line of business. The chatbot may be capable of understanding user requests/responses, providing relevant information, etc. Additionally, the chatbot may generate data from user interactions which the enterprise may use to personalize future support and/or improve the chatbot's functionality, e.g., when retraining and/or fine-tuning the chatbot.

The ML chatbot may provide advanced features as compared to a non-ML chatbot, which may include and/or derive functionality from a Large Language Model (LLM). The ML chatbot may be trained on a server, such as the server 106, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and/or coherence across multiple user utterances and/or prompts, which may require the ML chatbot to keep track of an entire conversation history as well as the current state of the conversation. The ML chatbot may rely on various techniques to engage in conversations with users, which may include the use of short-term and/or long-term memory. Short-term memory may temporarily store information (e.g., in the memory 122 of the server 106) that may be required for immediate use and/or may keep track of the current state of the conversation and/or to understand the user's latest input in order to generate an appropriate response. Long-term memory may include persistent storage of information (e.g., on database 126 of the server 106) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses. In some implementations, a database such as database 126 may store additional information that provides context for generating responses in the conversation. For example, the database 126 may store a profile containing the buyer's preferences. During the negotiation for the purchase of a vehicle, the ML chatbot may access the profile to generate responses to the seller that align with the buyer's preferences. Additionally, in some embodiments, the buyer's preferences may be used to fine-tune the ML chatbot such that the outputs are personalized to the buyer.

The system and methods to generate and/or train an ML chatbot model (e.g., via the ML module 140 of the server 106) which may be used by the ML chatbot, may consist of three steps: (1) a Supervised Fine-Tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and/or improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

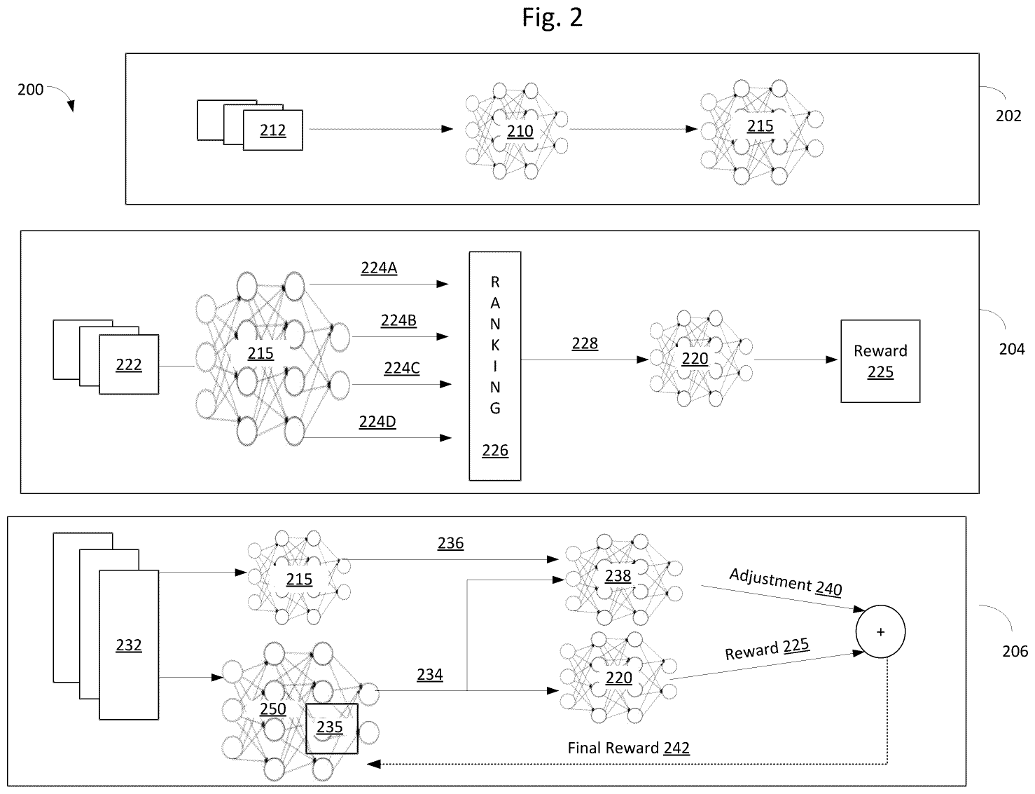

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., data structures for training data 212), and other blocks may represent output data (e.g., reward 225). Input and/or output signals may be represented by arrows labeled with corresponding signal names and/or other identifiers. The methods and systems may include one or more servers 202, 204, 206, such as the server 106 of FIG. 1.

In one aspect, the server 202 may fine-tune a pretrained language model 210. The pretrained language model 210 may be obtained by the server 202 and be stored in a memory, such as memory 122 and/or database 126. The pretrained language model 210 may be loaded into an ML training module, such as the MLTM 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122 and/or database 126.

In one aspect, the supervised training dataset 212 may include prompts and/or responses which may be relevant to negotiating for purchase of a vehicle. For example, the trained SFT ML model 215 may include a prompt requesting the buyer for further information on buyer preferences to negotiate for purchase of a vehicle. The responses from the trained SFT ML model 215 may include scores or rankings for terms associated with the purchase of a vehicle. The prompts and/or response may be via text, audio, multimedia, etc.

### Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize the reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data maintained at database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B, 224C, 224D when ranking 226 them from best to worst based upon the prompt-response pairs. The data labelers may rank the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 225 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank, via labeling the prompt-response pairs, prompt-response pair 222/224B as the most preferred answer; prompt-response pair 222/224A as a less preferred answer; and prompt-response 222/224C as the least preferred answer. The labeler may rank the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### RLHF to Train the ML Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using an adjustment function 238 to the SFT ML model 215 (which may not use a policy) response 236 of the same prompt 232. The server 206 may compute an adjustment 240 based upon the adjustment function 238 of the responses 234, 236. The adjustment 240 may reduce the distance between the responses 234, 236, i.e., a statistical distance measuring how one probability distribution is different from a second, in one aspect the response 234 of the ML chatbot model 250 versus the response 236 of the SFT model 215. Using the adjustment 240 to reduce the distance between the responses 234, 236 may avoid a server over-optimizing the reward model 220 and/or deviating too drastically from the human-intended/preferred response. Without the adjustment 240, the ML chatbot model 250 optimizations may result in generating responses 234 which are unreasonable but may still result in the reward model 220 outputting a high value for the reward 225. For the sake of clarity, the adjustment 240 is used to adjust scores of the response 232, 234, 236 to train the chatbot model 250 and/or the policy 235 thereof, and, as such, should not be understood to refer to an adjustment associated with an insurance product of any kind.

In one aspect, the responses 234 of the ML chatbot model 250 using the current policy 235 may be passed by the server 206 to the rewards model 220, which may return the scalar reward 225. The ML chatbot model 250 response 234 may be compared via the adjustment function 238 to the SFT ML model 215 response 236 by the server 206 to compute the adjustment 240. The server 206 may generate a final reward 242 which may include the scalar reward 425 offset and/or restricted by the adjustment 240. The final reward 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### Exemplary ML Model to Negotiate for Purchase of a Vehicle

In one embodiment, negotiating for purchase of a vehicle may use ML techniques.

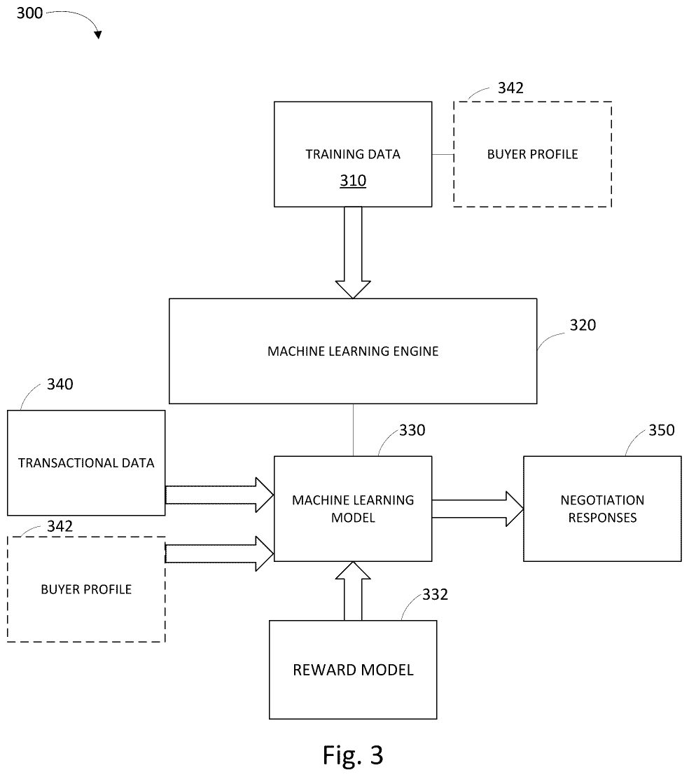

FIG. 3 depicts a combined block and logic diagram which schematically illustrates how an ML model may negotiate for purchase of a vehicle. Some of the blocks in FIG. 3 represent hardware and/or software components (e.g., ML engine 320), other blocks represent data structures or memory storing these data structures, registers, or state variables (e.g., training data 310), and other blocks represent output data (e.g., negotiation response 350). Input signals are represented by arrows labeled with corresponding signal names.

The ML engine 320 may include one or more hardware and/or software components, such as the MLTM 142 and/or the MLOM 144, to obtain, create, (re) train, operate and/or save one or more ML models 330. To generate the ML model 330, the ML engine 320 may use the training data 310.

As described herein, the server such as server 106 may obtain and/or have available various types of training data 310 (e.g., stored on database 126 of server 106). In one aspect, the training data 310 may labeled to aid in training, retraining and/or fine-tuning the ML model 330. The training data 310 may include transactional data associated with vehicle purchases. An ML model 330 may process training data 310 to derive associations between vehicle purchase terms and buyer characteristics. The training data 310 may also include historical transaction data of vehicle purchases that the ML model 330 may process to derive associations between vehicle types and the typical terms for purchases of the vehicle types.

While the exemplary training data includes indications of various types of training data 310, this is merely an example for case of illustration only. The training data 310 may include any suitable data which may associate vehicle purchase terms and buyer characteristics, as well as any other suitable data which may train the ML model 310 to negotiate for the purchase of a vehicle.

In one aspect, the server may continuously update the training data 310, e.g., based upon obtaining additional data from the buyer's transaction data, historical transaction databases, and/or other sources. Subsequently, the ML model 330 may be retrained/fine-tuned based upon the updated training data 310. Accordingly, negotiations for a vehicle may improve over time.

In one aspect, the ML engine 320 may process and/or analyze the training data 310 (e.g., via MLTM 142) to train the ML model 330 to generate negotiation responses 350 in negotiations for a vehicle. The ML model 330 may be trained to generate negotiation responses 350 via a regression model, k-nearest neighbor algorithm, support vector regression algorithm, and/or random forest algorithm, although any type of applicable ML model/algorithm may be used, including training using one or more of supervised learning, unsupervised learning, semi-supervised learning, and/or reinforcement learning.

In some implementations, the training data may include data indicating a buyer's preferences on purchase terms from a buyer profile 342 (such as a user profile maintained in the database 126 of FIG. 1). In these embodiments, the ML model 330 may be fine-tuned according to such preferences by freezing the initial layers so that such layers of the model are not affected during training, and only the top layers of the model are trained with the data from the buyer profile. In some implementations, additional layers that are fine-tuned with the buyer's preferences may be added to the model to the ML model 330.

In embodiments in which the ML model is fine-tuned based upon the buyer profile 342, the fine-tuning process may include updating a reward model 332 (such as the reward model 220) to generate a reward based upon the preferences indicated in the buyer profile 342. In some embodiments, a higher value may indicate a greater alignment with a buyer's preferences from the buyer profile. For example, if a buyer has a preference to use a particular database of public pricing data (such as the Kelley Blue Book), the reward function may define a reward value based upon a difference between a price in the proposed response and the price in the database.

As another example, the buyer profile 342 may include a set of bounds that indicate the buyer's personal preferences for purchasing a vehicle (such as a desired price range, interest rates, warranties, length of payment plans, etc.). Accordingly, proposed responses that include that are outside of the user's bounds may be given a low or negative reward value. In this manner, the reward model 332 may be used to tune the ML model 330 to generate outputs that maximize output of the reward model 332 such that the ML model 330 learns to generate responses that align with the buyer's preferences for negotiating for the purchase of a vehicle.

The reward model 332 may then be used to further tune the ML model 330. In some embodiments, the tuning process may involve adjusting the weights of an untuned models such that the generated responses more closely align with the preferences in the buyer profile 342.

Once trained, the ML model 330 may perform operations on one or more data inputs to produce a desired data output. In one aspect, the ML model 330 may be loaded at runtime (e.g., by MLOM 144) from a database (e.g., database 126 of server 106) to process the transactional data 340 data input. Transactional data 340 may include vehicle purchase history of a buyer, buyer financial information, historical transaction data of other buyers and/or any information which may be relevant to generating negotiation responses 350. The server, such as server 106, may obtain the transactional data 340 and use it as an input to generate negotiation responses 350. The server 106 may obtain the transactional data 340 via a user device, such as a mobile device associated with a buyer, or other sources such as public records, etc.

In one aspect, the ML model 330 may access the buyer profile 342 at runtime to generate negotiation responses 350 that better align with the buyer's preferences. As described above, the buyer profile 342 may include a set of bounds indicating the buyer's preferences. Accordingly, during the negotiation phase, the server 106 may validate that any proposed negotiation response 350 complies with the set of bounds. If the proposed negotiation response 350 does not comply with the set of bounds, the server 106 may re-input the prompt into the ML model 330 to generate a new negotiation response 350.

Once the ML model 330 has generated negotiation responses 350, the negotiation responses 350 may be provided to a device associated with a seller. For example, the server 106 may provide the negotiation responses 350 via a mobile app to a mobile device such as user device 102, in an email, via a graphical user interface on an AR device, a website, via a chatbot, and/or in any other suitable manner as further described herein.

### Exemplary Display

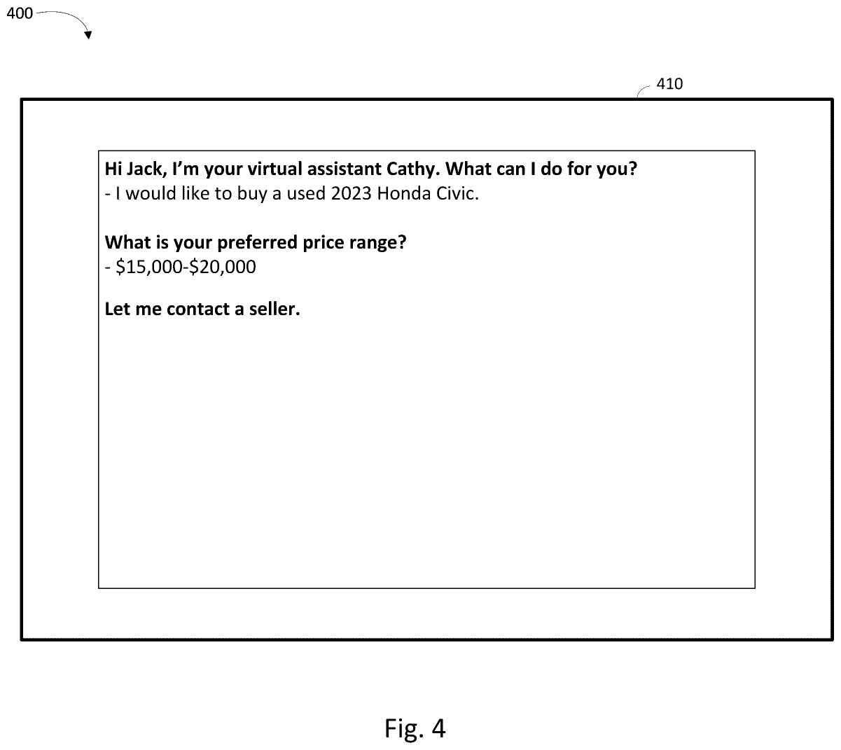

FIG. 4 depicts an exemplary display 400 of a mobile or desktop application (app) employing an ML chatbot (such as the chatbots 150 and/or 250) to negotiate for the purchase of a vehicle, according to one embodiment. Thus, the display 400 of FIG. 4 may depict a single communication session 410 between a user and the ML chatbot. The app may be executed by the user device 102 that is communicatively coupled with the server 106 via the network 110.

A user may interact with the app to purchase a vehicle. In the example of FIG. 4, a user (“Jack”) may use the app to access the ML chatbot to request assistance in purchasing a vehicle. A business enterprise may provide the app and/or ML chatbot to the user. In one example, the purpose of the app and/or ML chatbot may be to negotiate for the purchase of a vehicle. Accordingly, when the application is running, the ML chatbot may begin the process of suggesting vehicles. For example, the ML chatbot may suggest a vehicle in accordance with the techniques disclosed in application U.S. Application No. 63/462,101, the entire disclosure of which is hereby incorporated by reference in its entirety.

In another example, suggesting vehicles may be one of many functions the app and/or ML chatbot provides, and the user may explicitly request the ML chatbot to suggest vehicles e.g., by typing a request, by speaking, by selecting an icon, by selecting a link from a menu, or any other suitable means which allows the ML chatbot to detect the request. In one exemplary display 400, a user may begin the communication session 410 with the ML chatbot. The communication session 410 may include one or more of (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing, (v) communication using virtual reality, (vi) communication using augmented reality, (vii) blockchain entries, (vii) communication in the metaverse, and/or (viii) any other suitable form of communication. The communication session 410 may include instant messaging, interactive icons, and/or an interactive voice session via which the user is able to type and/or speak his or her natural language responses via the user device. In FIG. 4, the communication session 410 begins when the ML chatbot (“Cathy”) greets the user and asks for information. The user may respond with a request to purchase a specific vehicle.

The ML chatbot may request additional information regarding the user's preferences to better negotiate for the purchase of a particular vehicle, as shown in FIG. 4. For example, the ML chatbot may ask one or more follow-up questions for the user's preference on price range, payment plans, warranties, and/or other questions about terms that would be acceptable to the buyer. In the case where a user is interested in trading in a vehicle, the ML chatbot may request additional information regarding the user's current vehicle in order to determine a value of the current vehicle. For example, the ML chatbot may request make/model information, mileage information, vehicle condition data, etc. In some embodiments, the information about the vehicle being traded in may be provided to potential sellers and/or lenders as part of the negotiation processes described herein. Referring to the communication session 410 as illustrated in FIG. 4, the ML chatbot may ask follow-up questions regarding the buyer's preferred price range. Once the chatbot has sufficient information, the chatbot may search for sellers that have a particular vehicle and begin negotiating for purchase of the vehicle.

### Exemplary Negotiation of Vehicle Purchase

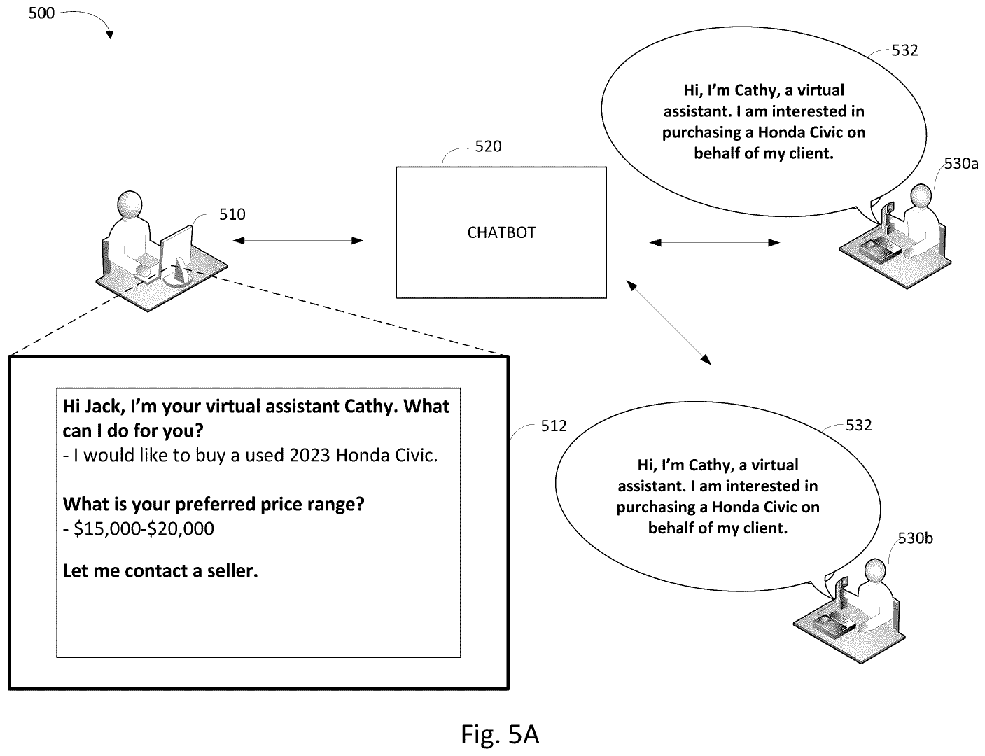

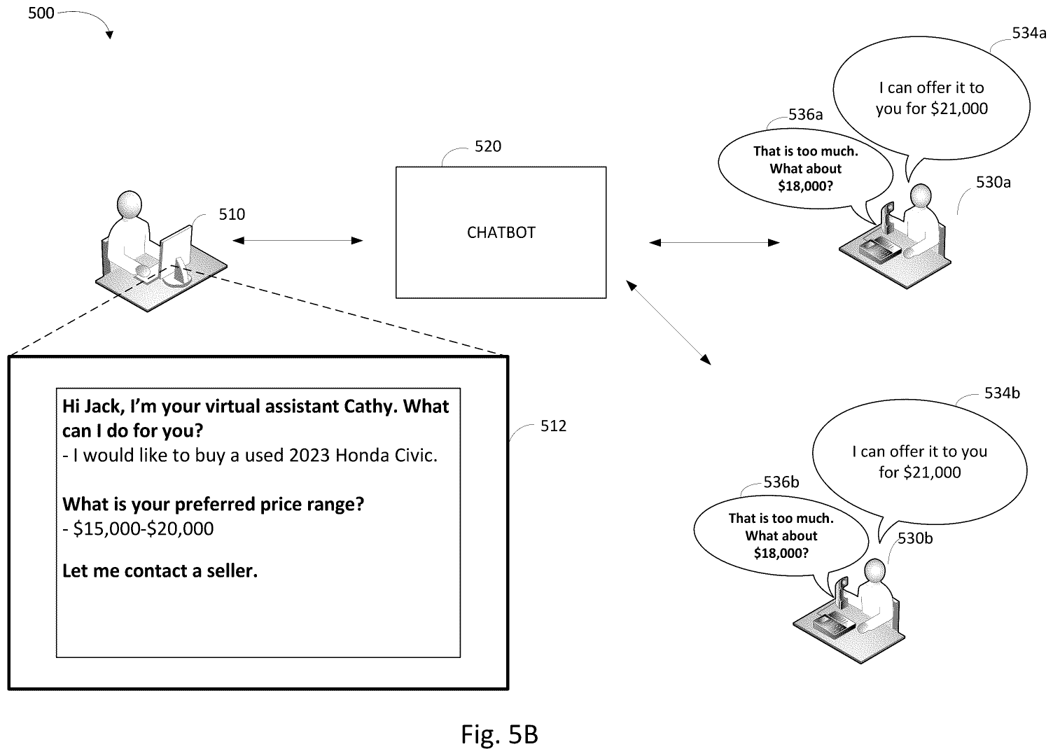

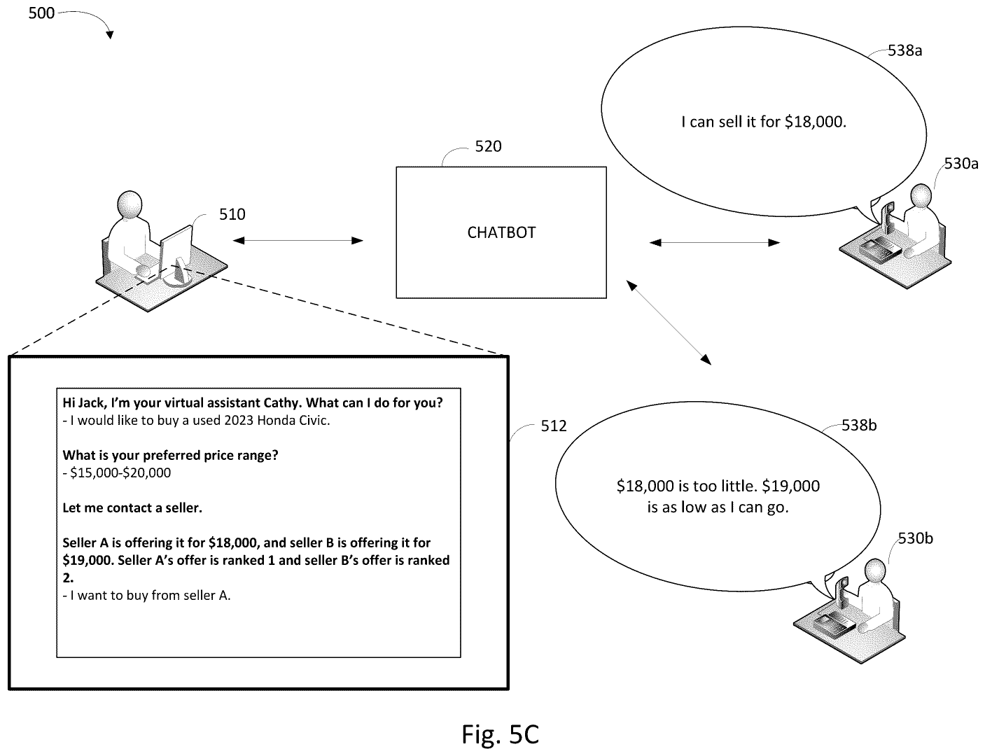

FIGS. 5A-5C show an exemplary negotiation for the purchase of a vehicle. As shown in FIGS. 5A-5C, a generative AI such as an AI/ML chatbot and/or voice bot 520 hosted by a server (such as the server 106 of FIG. 1) may be used to negotiate for the purchase of a vehicle. A buyer may communicate with the chatbot with a device 510. The chatbot 520 may be trained in accordance with the techniques described with respect to FIGS. 2 and 3.

FIG. 5A depicts the chatbot 520 initiating negotiations with a seller of a vehicle. In one aspect, the chatbot 520 may search the internet for sellers whose inventory includes or likely includes a particular vehicle available for purchase. The chatbot 520 may initiate communications with one or more seller(s) 530a and 530b to initiate negotiation for the vehicle by sending an inquiry 532 to the one or more sellers. A seller of a vehicle 530a or 530b may be a new car dealership, a used car dealership, private seller, online retailer, etc., and/or a computer system associated therewith. The chatbot 520 may communicate with the sellers 530a and 530b via (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing, and/or any other suitable communication means. The chatbot 520 may operate in a conversational manner and provide and/or collect information without any human intervention.

FIG. 5B, depicts the chatbot 520 negotiating with the sellers 530a and 530b. The chatbot 520 may receive terms 534a and 534b from the sellers 530a and 530b, respectively. In one aspect, the chatbot 520 may receive audio data via an audio connection from the sellers 530a and 530b (e.g., as part of a voice call initiated by the chatbot 520). The chatbot 520 may transcribe the audio data into unformatted text. An NLP module, such as the NLP module 148, may convert the unformatted text into structured data that is input into the chatbot 520 to generate responses 536 to the terms 534. The response to the terms 534 may be an acceptance of the terms 534, a refusal of the terms 534, a counter-offer based upon the terms 534, and/or another type of response associated with negotiations for purchase of a vehicle. It should be appreciated that, as illustrated in FIG. 5B, the chatbot 520 may provide the response 536 to the sellers 530, without providing the response 536 to the buyer device 510.

In some implementations, the chatbot 520 may be configured to account for the buyer's personal preferences for purchasing a vehicle when generating responses. These preferences may be stored in a user database, such as the database 126 of FIG. 1. For example, the buyer may have a lower budget for price than what a pretrained generative AI model would otherwise classify as acceptable. Other examples of preferences may include interest rates, warranties, length of payment plan, etc.

In scenarios where the chatbot 520 is negotiating with multiple sellers 530 (such as in the scenario illustrated in FIG. 5B), the chatbot 520 may wait until the terms 534 are received from each of the sellers 530 before processing the terms 534 to generate the responses 536. The chatbot 520 may analyze and/or process the received terms 534 to interpret, understand and/or extract relevant information within the terms 534. For example, the chatbot 520 may determine that the price in terms 534 is higher than the buyer's expected budget.

A server, such as the server 106 of FIG. 1, may collect and/or process the information from the sellers 530a and 530b via the chatbot 520. The server may analyze and/or process the collected information to interpret, understand and/or extract relevant information within one or more responses from the sellers 530a and 530b.

In response to the offer, the chatbot 520 may analyze the terms received from the sellers 530a and 530b. The chatbot 520 analyzed the information to deem the offered price ($21,000) from both sellers 530a and 530b to not fit within the buyer's preferences. The chatbot 520 may respond to the sellers 530a and 530b with counteroffers 536a and 536b with terms that better suit the buyer's preferences (“What about $18,000?”).

FIG. 5C depicts the end of the negotiation with the sellers 530a and 530b. The sellers 530a and 530b give final offers 538a and 538b, respectively. The chatbot 520 may provide the information to a buyer using a user device 510 in a communication session 512. The chatbot 520 may communicate with the user device 510 via audio, text messages, instant messages, video, email, application notifications, and/or any other suitable communication means. The user device 510 may be one or more of desktop computers, laptops, smartphones, wearables, smart watches, smart contact lenses, smart glasses, augmented reality glasses, virtual reality headsets, and/or any other suitable communication device. The chatbot 520 may also provide advice on which set of terms is better, such as by ranking the terms from sellers 530a and 530b (“Seller A's offer is ranked 1 and seller B's offer is ranked 2.”). The user may then input into the chatbot 520 which offer to accept (“I want to buy from seller A”).

In some implementations, the negotiation process may include scheduling time for the buyer and seller to meet in-person. For example, the buyer and seller may meet so that a buyer may inspect the vehicle, test-drive the vehicle, or gain physical possession of a vehicle. The chatbot 520 may be configured to schedule a meeting time between the buyer and the seller based upon schedule data associated with the buyer and seller that is input into the chatbot 520 responsive to the buyer and the seller reaching an agreement to meet. In some embodiments, the chatbot 520 may obtain scheduling data from the buyer device 510 and a seller device 530a or 530b. In other embodiments, the scheduling data is synchronized with the one or more servers that host the chatbot 520. Regardless, the chatbot 520 may use the scheduling data to schedule a time for inspecting the vehicle, test-driving the vehicle and/or transferring possession of the vehicle. The chatbot 520 may be trained to identify openings in both the buyer's and seller's schedule and schedule an appropriate amount of time for a type of appointment itself and/or to route the scheduling data to an application hosted by the one or more servers dedicated to scheduling meetings. It should be appreciated that the duration of the meeting may vary depending upon the purpose of the meeting. For example, a test drive may require a longer appointment time than physically transferring ownership of the vehicle.

In some implementations, the negotiation process may include securing a loan for the purchase of the vehicle. For example, the seller, such as a private seller, may not be able to provide financing as part of the purchase, or a buyer may wish to independently arrange financing. The chatbot 520 may obtain financial data associated with the buyer to request a loan from a lending institution. In some embodiments, the chatbot 520 may obtain the financial data from a buyer device 510. The chatbot 520 may be configured to contact lenders (e.g., banks, credit unions, financing companies, etc.) to request for a loan for purchasing a vehicle. After the chatbot 520 has received one or more responses to the request for a loan from the lenders, the chatbot 520 may output the responses to the buyer device 510. The responses may indicate specific terms of the loan for approval by the buyer.

It should be appreciated that while FIGS. 5A-5C show one example negotiation between a buyer and a seller, in other negotiations additional, alternative, or fewer terms may be negotiated, including those described elsewhere herein.

### Exemplary Computer-Implemented Methods for Negotiating for a Vehicle

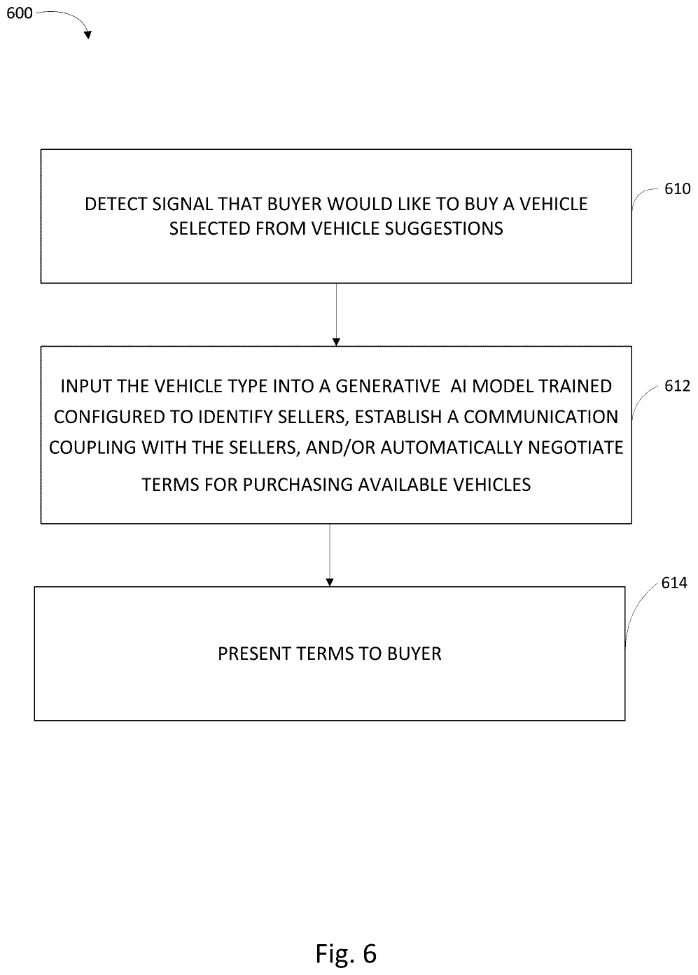

FIG. 6 depicts a flow diagram of an exemplary computer-implemented method 600 for implementing generative AI (e.g., an AI or ML chatbot and/or voice bot) to negotiate for the purchase of a vehicle. One or more steps of the method 600 may be implemented as a set of instructions stored on a computer-readable memory and executable on one or more processors. The method 600 of FIG. 6 may be implemented via the exemplary computing environment 100 of FIG. 1.

At block 610, the computer-implemented method 600 may include receiving driver data. The server 106 may detect a signal that a buyer would like to purchase a specific type of vehicle.

At block 612, the computer-implemented method 600 may include inputting the vehicle type into a generative AI model, wherein the generative AI model is configured to (1) identify one or more sellers of the vehicle type, (2) establish a communication coupling with the one or more sellers of the vehicle type, and/or (3) automatically negotiate one or more terms for purchasing available vehicles of the vehicle type. The generative AI model may be trained on transactional data associated with vehicle purchases to learn a relationship between vehicle purchase terms and user characteristics. The generative AI model may be trained using supervised learning, unsupervised learning, or reinforcement learning techniques. In some implementations, the generative AI model may use a set of bounds indicating the buyer's preferences on purchase terms (e.g., price, payment plan, warranties, etc.) from a buyer profile to negotiate for the purchase of a vehicle. In some implementations, the generative AI may obtain and analyze data on regarding the buyer's preferences to generate the buyer profile. In some embodiments, the method 600 may include obtaining historical transaction data from a database of transactions. The historical transaction data may be input into the generative AI model configured to negotiate terms based upon such data.

In some embodiments, the computer-implemented method 600 may include inputting the vehicle type and the data associated with a current vehicle associated with the buyer into the generative AI model. The generative AI model may be configured to analyze such information and/or determine the value of the current vehicle to be used in negotiating a trade-in of the current vehicle. In some embodiments, the method 600 may include obtaining the buyer's financial information and inputting the financial information into the generative AI model. The generative AI model may be configured to use that information to contact lending institutions to secure a loan for financing the purchase of the vehicle. The method 600 may also include obtaining scheduling data from the buyer and the seller. The generative AI model may be configured to schedule a meeting time between the buyer and the seller based upon the scheduling data for inspecting the vehicle, test-driving the vehicle, and/or transferring possession of the vehicle to the buyer.

At block 614, the computer-implemented method 600 may include presenting the negotiated terms to the buyer. The negotiated terms may be presented to the driver in text, images, audio, video, augmented reality and/or virtual reality. Additionally or alternatively, the output and/or negotiated terms may be text, textual, visual, or graphical output and/or negotiated terms that are presented on a display, screen or other medium, and/or verbal or audible output and/or negotiated terms presented via a voice bot, chatbot, or other means. In some embodiments, the generative AI model may be trained on historical transaction data to generate scores that the terms associated with vehicle purchases. The generative AI model may be configured to rank terms received from sellers based upon the scores.

In some embodiments, the method may include detecting a signal from the buyer that the terms associated with a particular vehicle are acceptable, and/or complete the purchase of the vehicle with the seller of the particular vehicle. The method may further include rejecting the terms of purchase of a vehicle from other sellers.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method for implementing generative artificial intelligence to negotiate for a purchase of a vehicle, the method comprising:
detecting, by one or more processors, a signal that a buyer would like to purchase a vehicle, wherein the signal indicates a vehicle type of the vehicle; and
inputting, by the one or more processors, the vehicle type into a generative artificial intelligence (AI) model, wherein the generative AI model is trained on transactional data associated with vehicle purchases to learn a relationship between vehicle purchase terms and buyer characteristics, and is configured to:
identify one or more sellers of the vehicle type,
establish a communication coupling with the one or more sellers of the vehicle type,
automatically negotiate, with the one or more sellers, one or more terms for purchasing available vehicles of the vehicle type; and
present the one or more terms to the buyer to facilitate purchase of a particular vehicle of the available vehicles from a particular seller.

2. The computer-implemented method of claim 1, wherein:
inputting, by the one or more processors, the vehicle type into the generative AI model comprises inputting the vehicle type and data associated with a current vehicle associated with the buyer; and
the generative AI model is further configured to:
analyze the data associated with the current vehicle, and
determine a value of the current vehicle based upon the data.

3. The computer-implemented method of claim 2, wherein to automatically negotiate the one or more terms, the generative AI model is configured to:
negotiate the one or more terms based upon a trade-in of the current vehicle at the determined value.

4. The computer-implemented method of claim 1, wherein the generative AI model is further configured to:
detect a signal from the buyer that the one or more terms associated with the particular vehicle are acceptable, and
complete the purchase of the particular available vehicle with the particular seller.

5. The computer-implemented method of claim 4, wherein the generative AI model is further configured to:
reject the one or more terms for purchase of the available vehicles offered by sellers other than the particular seller of the one or more sellers.

6. The computer-implemented method of claim 1, further comprising:
obtaining, by the one or more processors, scheduling data associated with the buyer and/or the seller; and
inputting, by the one or more processors, the scheduling data to the generative AI model;
wherein the generative AI model is further configured to automatically schedule a meeting time between the buyer and seller based upon the scheduling data.

7. The computer-implemented method of claim 1, further comprising:
obtaining, via one or more processors, financial information associated with the buyer; and
inputting, by the one or more processors, the financial information into the generative AI model;
wherein the generative AI model is configured to:
establish a communication coupling with one or more lending institutions to transmit a loan request associated with the purchase of the particular vehicle, and
output, to the buyer, a response from the one or more lending institutions.

8. The computer-implemented method of claim 1, wherein the one or more terms presented to the buyer is in a form of one or more of the following: (i) text; (ii) images; (iii) audio; (iv) video; (v) augmented reality (AR) and/or (vi) virtual reality (VR).

9. The computer-implemented method of claim 1, wherein the generative AI model includes at least one of: (i) an AI or machine learning (ML) chatbot and/or (ii) an AI or ML voice bot.

10. The computer-implemented method of claim 1, further comprises:
retrieving, from a buyer profile, a set of bounds indicating one or more acceptable values for one or more prospective terms; and
inputting, by the one or more processors, the set of bounds into the generative AI model;
wherein the generative AI model is configured to negotiate the one or more terms within the input set of bounds.

11. The computer-implemented method of claim 1, further comprising:
obtaining, by the one or more processors, buyer preference data; and
inputting, by the one or more processors, the buyer preference data into the generative AI model;
wherein the generative AI model is configured to:
analyze the buyer preference data to generate a set of bounds, and negotiate the one or more terms within the generated set of bounds.

12. The computer-implemented method of claim 1, further comprising:
obtaining, by the one or more processors, historical transaction data from a transaction database; and
inputting, by the one or more processors, the historical transaction data from a transaction database into the generative AI model;
wherein the generative AI model is configured to negotiate the one or more terms based upon the historical transaction data.

13. The computer-implemented method of claim 1, wherein:
the generative AI model is (i) trained on historical transaction data to generate scores that evaluate a plurality of terms associated with vehicle purchases and (ii) configured to rank the one or more terms received from the one or more sellers using the respective scores.

14. A computer system for implementing generative artificial intelligence to negotiate for a purchase of a vehicle, the system comprising:
one or more processors; and
one or more non-transitory memories storing computer-executable instructions that, when executed by the one or more processors, cause the system to:
detect a signal that a buyer would like to purchase a vehicle, wherein the signal indicates a vehicle type of the vehicle; and
input the vehicle type into a generative artificial intelligence (AI) model, wherein the generative AI model is trained on transactional data associated with vehicle purchases to learn a relationship between vehicle purchase terms and buyer characteristics, and is configured to:
identify one or more sellers of the vehicle type,
establish a communication coupling with the one or more sellers of the vehicle type,
automatically negotiate, with the one or more sellers, one or more terms for purchasing available vehicles of the vehicle type, and
present the one or more terms to the buyer to facilitate purchase of a particular vehicle of the available vehicles from a particular seller.

15. The computer system of claim 14, wherein to input the vehicle type into the generative AI model the instructions, when executed by the one or more processors, cause the system to:
input the vehicle type and data associated with a current vehicle associated with the buyer; and
the generative AI model is further configured to:
analyze the data associated with the current vehicle, and
determine a value of the current vehicle based upon the data.

16. The computer system of claim 15, wherein to automatically negotiate the one or more terms, the generative AI model is configured to:
negotiate the one or more terms based upon a trade-in of the current vehicle at the determined value.

17. The computer system of claim 14, wherein the generative AI model is further configured to:
detect a signal from the buyer that the one or more terms associated with the particular vehicle are acceptable, and
complete the purchase of the particular available vehicle with the particular seller.

18. The computer system of claim 17, wherein the generative AI model is further configured to:
reject the one or more terms for purchase of the available vehicles offered by sellers other than the particular seller of the one or more sellers.

19. The computer system of claim 14, wherein the instructions, when executed by the one or more processors, further cause the system to:
obtain financial information associated with the buyer; and
input the financial information into the generative AI model;
wherein the generative AI model is configured to:
establish a communication coupling with one or more lending institutions to transmit a loan request associated with the purchase of the particular vehicle, and
output, to the buyer, a response from the one or more lending institutions.

20. A non-transitory computer-readable medium storing processor-executable instructions for implementing generative artificial intelligence to negotiate for a purchase of a vehicle, the instructions, when executed by one or more processors, cause the one or more processors to:
detect a signal that a buyer would like to purchase a vehicle, wherein the signal indicates a vehicle type of the vehicle; and
input the vehicle type into a generative artificial intelligence (AI) model, wherein the generative AI model is trained on transactional data associated with vehicle purchases to learn a relationship between vehicle purchase terms and buyer characteristics, and is configured to:
identify one or more sellers of the vehicle type,
establish a communication coupling with the one or more sellers of the vehicle type,
automatically negotiate, with the one or more sellers, one or more terms for purchasing available vehicles of the vehicle type; and
present the one or more terms to the buyer to facilitate purchase of a particular vehicle of the available vehicles.
